(19) United States
(12) Patent Application Publication
(10) Pub. No.: US 2025/0290333 A1
(43) Pub. Date: Sep. 18, 2025

(54) Steel Component Alignment Tool

(71) Applicant: James Claude Murphy, Burley, ID (US)

(72) Inventor: Ricardo Luis Reyes, Burley, ID (US)

(21) Appl. No.: 19/079,320

(22) Filed: Mar. 13, 2025

Related U.S. Application Data
(60) Provisional application No. 63/564,913, filed on Mar. 13, 2024.

(51) Int. Cl. E04G 17/14; B66F 15/00

(52) U.S. Cl. CPC E04G 17/14; B66F 15/00

(57) ABSTRACT

A steel component alignment tool that is used to align adjacent steel components, such as the framework in a concrete form. Adjacent sections of framework have openings that align when the forms are aligned. The head of the tool is tapered from a narrow end to a wider base such that the tapered tool end can be inserted into a pair of misaligned openings, and hit with a hammer or similar striking object to force the tapered head of the tool into the openings. This force causes the adjacent framework to align.

### CROSS-REFERENCE TO RELATED APPLICATIONS

This application claims the benefit of U.S. Provisional Application No. 63/564,913, filed Mar. 13, 2024, the disclosure of which is incorporated by reference.

### FIELD OF THE INVENTION

The disclosure generally relates to the field of hand tools for aligning steel supports such as steel support frames used in commercial concrete forms and I-beams, in particular an alignment tool having a head having a tapered end extending from a radius elbow that connects the head to a handle that extends generally perpendicular to the head.

### BACKGROUND OF THE INVENTION

Adjacent steel components can be formed with apertures that align when the steel components are aligned. An example of such a system is that of a commercial concrete form. Commercial concrete forms typically use a form system that uses a frame structure supporting a substrate that provides a bearing surface to hold the cement while it cures. The frame is typically a steel frame that is modular and assembled in components. These components are aligned and secured together using clamps or fasteners. The steel frame structure serves to support the substrate such as plywood or other sheathing that provides the structure into which the concrete is poured. One issue is that when the steel support frame is assembled, imperfections in the floor can make it difficult to align the steel frame. The steel frame typically has vertical components that are required to be aligned and then fastened together. These vertical components have through holes in the vertical supports that must be aligned prior to securing the structure together. Typically the tapered end of a spud wrench is inserted through the adjacent openings of two adjacent steel supports. This forces the alignment of the adjacent steel supports. However, the spud wrench can be difficult to impart force to align the bolt holes, as well as making it difficult to remove if forced into the bolt holes to align the bolt holes as the spud wrench is positioned very close to the panel forms. Accordingly, what is needed is an improved tool and method for aligning the bolt holes of the forms, as well as other steel structural supports such as I-flanges, I beams in the erection of steel framed buildings, and alignment of other steel components.

### SUMMARY

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

What is disclosed is an improved steel component alignment tool having an elongate handle extending from a first end of said tool to an elbow. The elbow being a connection between the elongate handle to a tapered alignment head. The tapered alignment head extending generally perpendicular to the elongate handle. The tapered alignment head tapering toward a second end of the alignment tool such that the head comprises a tip forming said second end of the tool.

The tool having a striking area configured for striking a hammer onto the tool opposite the tapered alignment head to force said tapered alignment head through misaligned apertures in adjacent steel components. The striking area can be configured on the elbow or on a second end of the tapered alignment head. The elbow can be radiused (aka curved), or it can be a perpendicular joint between the handle and the head.

The elongate handle is configured to provide leverage to said tapered alignment head to remove the tapered alignment head from said apertures following alignment of said apertures.

The tapered alignment end is preferably approximately seven inches long and wherein said handle is between approximately two feet or greater in length, and less than or equal to approximately three feet in length.

What is further disclosed is a method of using the tool to align two adjacent steel components, such as two adjacent uprights of a frame of a concrete form. The method involves the step of providing a device according to the description herein. A further step of inserting the tapered alignment head through two adjacent alignment openings of two adjacent steel support structures to align said structures. A next step of applying an impact force to said striking area of said tool to drive said tapered head into said apertures causing said apertures and said steel components to align is provided.

After the adjacent components are aligned, the step of applying a clamp to retain alignment of said apertures and said steel components to align occurs. Subsequently the step of applying force to said elongate handle to apply leverage said tapered head to remove said tapered head from said aligned apertures.

### BRIEF DESCRIPTION OF THE FIGURES

FIG. 1 is a side view of an embodiment of a steel component alignment tool.

FIG. 2 is an isometric view of the steel component alignment tool of FIG. 1.

FIG. 3 is a back view of the steel component alignment tool of FIG. 1.

FIG. 4 is a top view of the steel component alignment tool of FIG. 1

FIG. 5 is a perspective view of an assembled concrete form have modular steel framing components.

FIG. 6 is a perspective view of a step in using the steel component alignment tool to align vertical frame members of a concrete form system.

FIG. 7 is a perspective view of a subsequent step in using the steel component alignment tool to align the steel components of FIG. 6.

FIG. 8 illustrates a perspective view of a step of securing the steel components of FIGS. 6 and 7 after the steel components have been aligned with the alignment tool.

FIG. 9 illustrates a second view of the step of FIG. 8.

FIG. 10a illustrates an isometric view of an alternate embodiment of a steel component alignment tool.

FIG. 10b illustrates a side view of the embodiment of FIG. 10a.

FIG. 11a illustrates an isometric view of an alternate embodiment of a steel component alignment tool.

FIG. 11b illustrates a side view of the embodiment of FIG. 11a.

FIG. 12a illustrates an isometric view of an alternate embodiment of a steel component alignment tool.

FIG. 12b illustrates a side view of the embodiment of FIG. 12a.

FIG. 12a illustrates an isometric view of an alternate embodiment of a steel component alignment tool.

FIG. 12b illustrates a side view of the embodiment of FIG. 12a.

FIG. 13a illustrates an isometric view of an alternate embodiment of a steel component alignment tool.

FIG. 13b illustrates a side view of the embodiment of FIG. 13a.

FIG. 14a illustrates an isometric view of an alternate embodiment of a steel component alignment tool.

FIG. 14b illustrates a side view of the embodiment of FIG. 14a.

FIG. 15a illustrates an isometric view of an alternate embodiment of a steel component alignment tool.

FIG. 15b illustrates a side view of the embodiment of FIG. 15a.

FIG. 16a illustrates an isometric view of an alternate embodiment of a steel component alignment tool.

FIG. 16b illustrates a side view of the embodiment of FIG. 16a.

FIG. 17a illustrates an isometric view of an alternate embodiment of a steel component alignment tool.

FIG. 17b illustrates a side view of the embodiment of FIG. 17a.

FIG. 18a illustrates an isometric view of an alternate embodiment of a steel component alignment tool.

FIG. 18b illustrates a side view of the embodiment of FIG. 18a.

FIG. 19a illustrates an isometric view of an alternate embodiment of a steel component alignment tool.

FIG. 19b illustrates a side view of the embodiment of FIG. 18b.

### DETAILED DESCRIPTION OF THE FIGURES

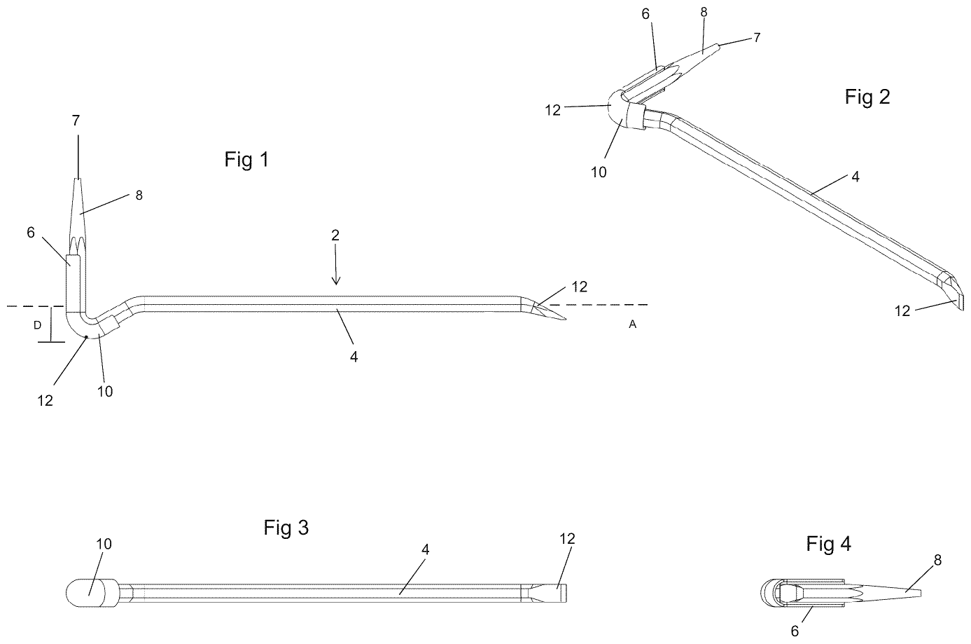

FIG. 1 depicts an isometric side view of the preferred embodiment of the tool 2. The tool has an elongate handle 4 and a head 6 that extends to a tapered alignment end 8. The handle and the head are connected by a strike zone 12 that is configured for hammering or otherwise implying force on the radiused elbow 10 that connects the handle to the head. The strike zone can be reinforced, such as by a plate welded to the strike zone, or by a thickened strike zone. The tapered alignment end 8 is configured with a taper for insertion in to neighboring bolt holes of adjacent steel components. The rigid metal taper alignment end is structurally rigid such that forcing the end into the neighboring bolt holes causes alignment of the adjacent steel structures. In the embodiment depicted in FIGS. 1-4 the handle of the alignment tool is a hexagonal bar having a pry bar second end 9.

FIG. 2 illustrates a perspective view of a preferred embodiment of the described formed alignment tool. The reinforced elbow in the depicted embodiment is formed by welding and additional steel and reinforcement plate to the elbow. FIG. 3 illustrates a back isometric view depicting the handle 4 extending to the elbow 10.

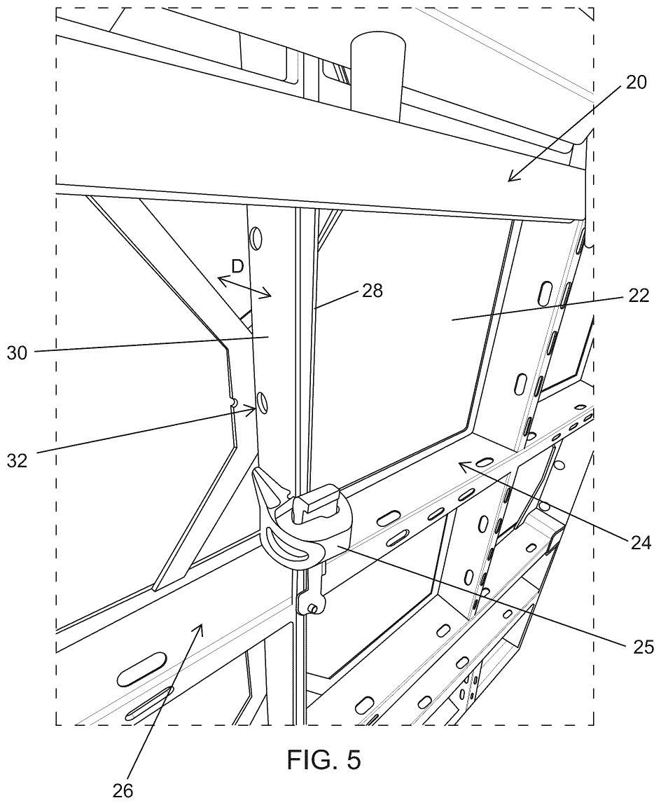

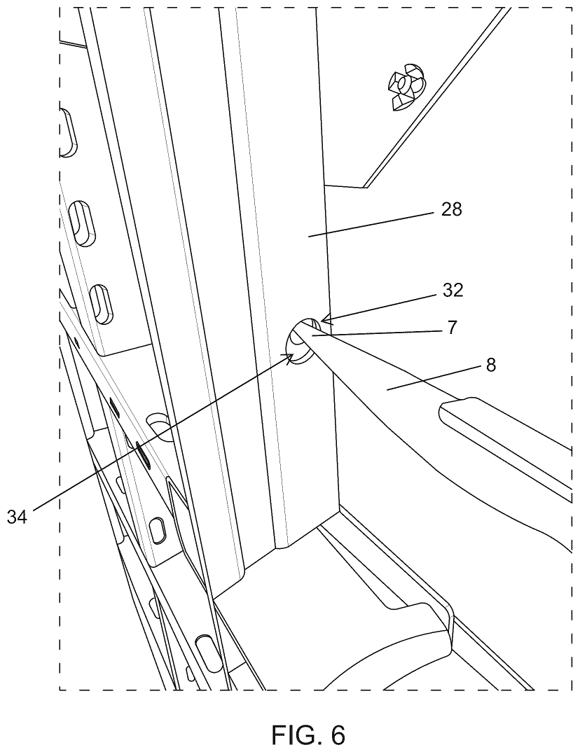

FIG. 4 illustrates a top isometric view illustrating the head 6 extending to the tapered alignment end. In a preferred embodiment the radiused elbow extends away from an axis A defined by the central axis of the handle. This elbow extends away from the tapered end and away from the axis a distance D. However, the radiused elbow can be formed in the same axis A.

FIG. 5 illustrates an assembled form having two steel upright support sections 24, 26. The form structure is typically modularly assembled, with sections of the form frame being assembled and connected together by one or more clamps 25. The assembled form structure 20 has adjacent steel support frames 24, 26 that are secured together by clamp 25. The adjacent modular steel structures have adjacent vertical supports 28, 30. The form structure has paneling 22 that provides support for cement that is poured into the form and allowed to cure. The adjacent vertical support rails utilize alignment openings 32, 34 (shown in FIG. 6). In order for the steel frame to be positioned in a correct location, the adjacent holes 32, 34 must be aligned. FIG. 5 illustrates a fully assembled form in which the adjacent vertical supports have been aligned, and the clamp has been secured.

FIG. 6 illustrates the step of positioning the tapered alignment end into the misaligned openings of adjacent vertical support structures. Vertical support structure 28 is shown with opening 34 in vertical support 28. The opposing alignment hole 32 is shown in a misaligned state through the opening in vertical support 28. The tip 7 of the tapered alignment end of the tool has been positioned into the opening 34 and extend through the steel support 28 into the opposing alignment opening 32 of the adjacent upright support 30 (shown in FIG. 5). As the tapered end is forced into the misaligned openings of the misaligned vertical supports, the progressive taper of the tapered alignment end of the tool forces the alignment of the vertical supports.

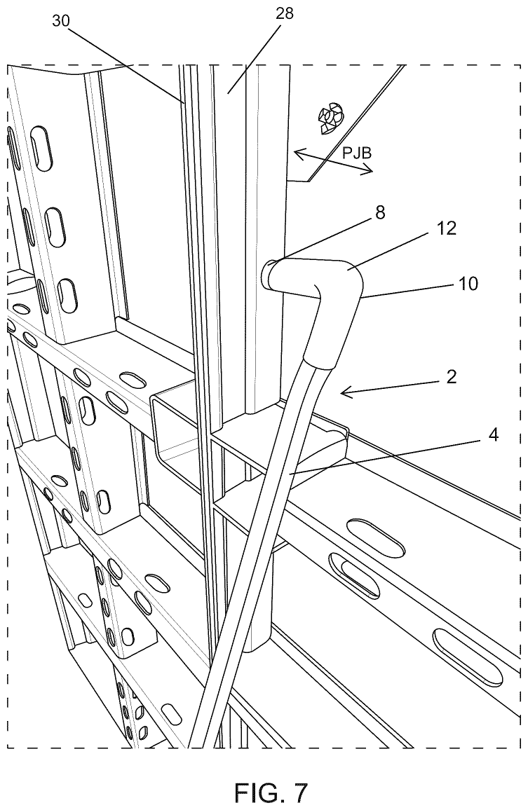

FIG. 7 illustrates the alignment tool having been forced further into the misaligned openings, causing alignment of the adjacent vertical supports 28, 30. The tapered alignment end 8 is positioned through the adjacent openings. The taper in the head forces the alignment of the adjacent steel components. A hammer, such as a sledge hammer can be used to hit the end of the elbow 10 to force alignment of the steel components. In the depicted embodiment the elbow is a reinforced elbow. The handle 4 extends perpendicularly from the head such that force can be applied along force line B to pry the steel vertical supports into place. Subsequently, when the vertical steel supports are positioned in place, the clamp 45 can be installed, securing the form in place.

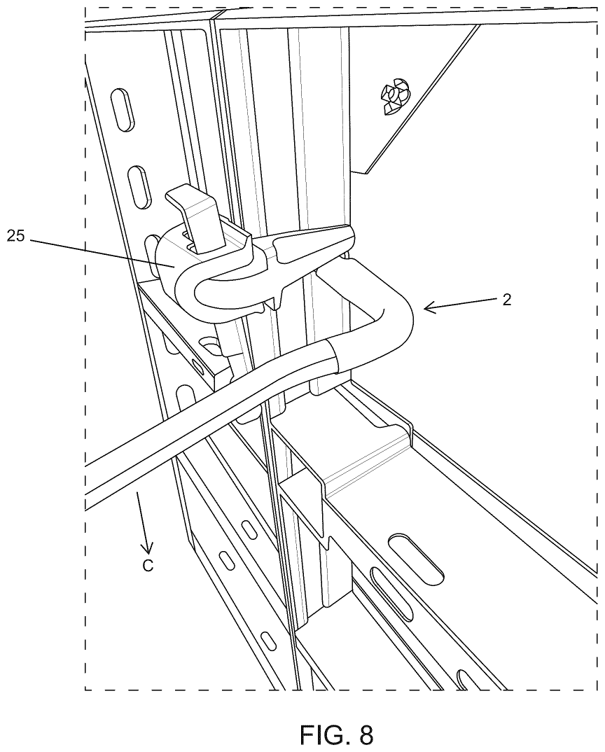

FIG. 8 illustrates the step of the clamp 25 installed to secure the adjacent vertical supports in place. The alignment tool can then be released by pulling the handle away from the aligned vertical support. The elongate handle of the alignment tool provides additional leverage for the user to pry the tapered alignment head from the aligned openings.

FIG. 9 illustrates the position of the tapered alignment end of the tool when the adjacent vertical supports are aligned. The tapered alignment end extends through the aligned openings of the vertical supports. The tapered alignment end has a tip and tapers to a wider section that is configured to occupy the opening of the depicted vertical supports when the vertical supports are aligned. A clamp 25 is shown installed on the vertical supports, securing the vertical supports in position.

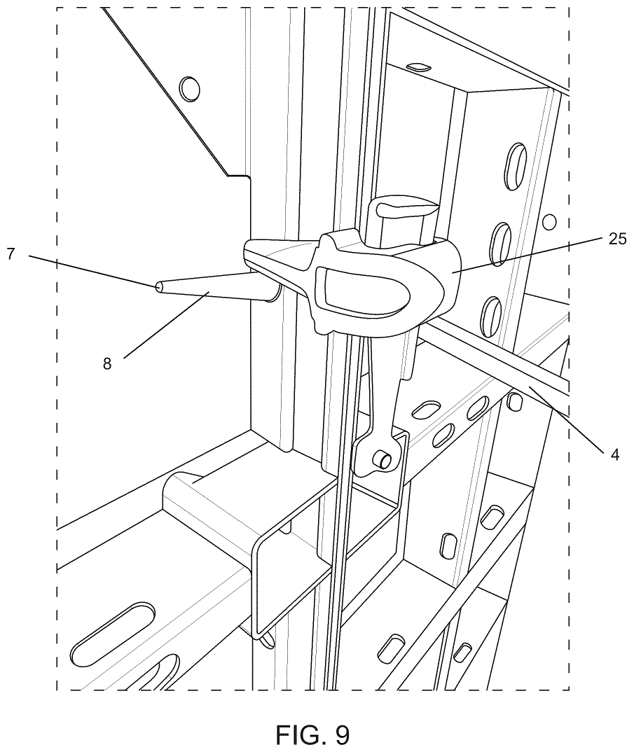

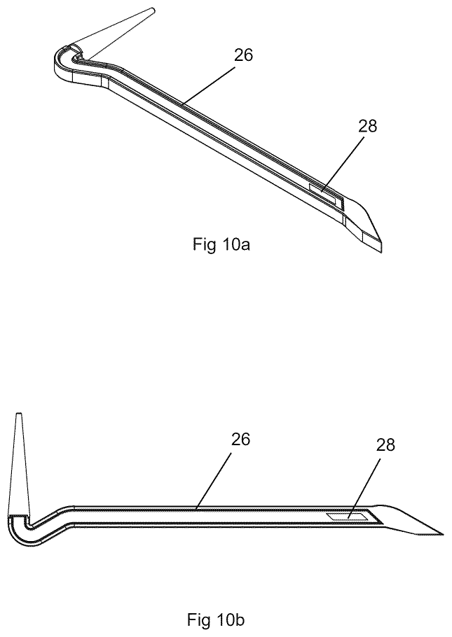

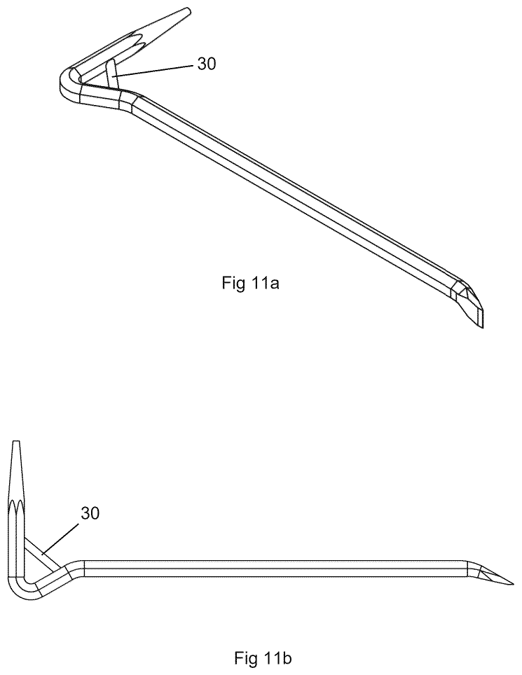

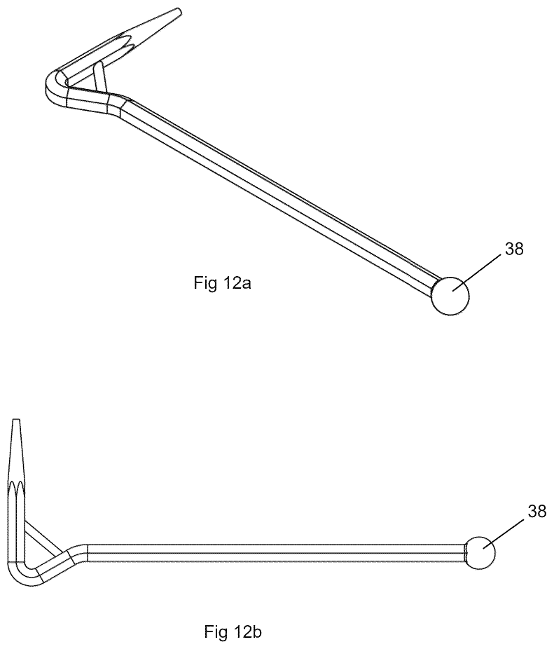

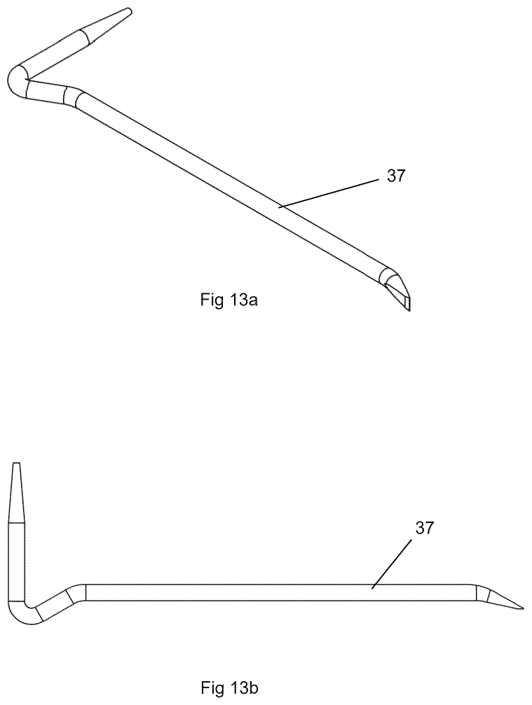

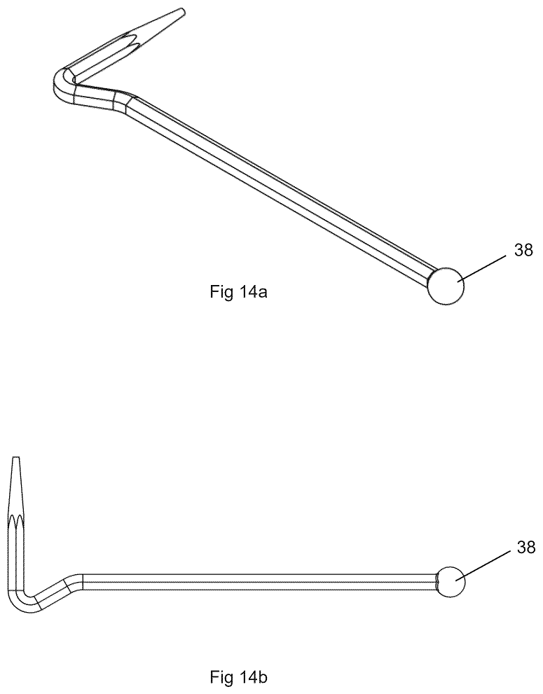

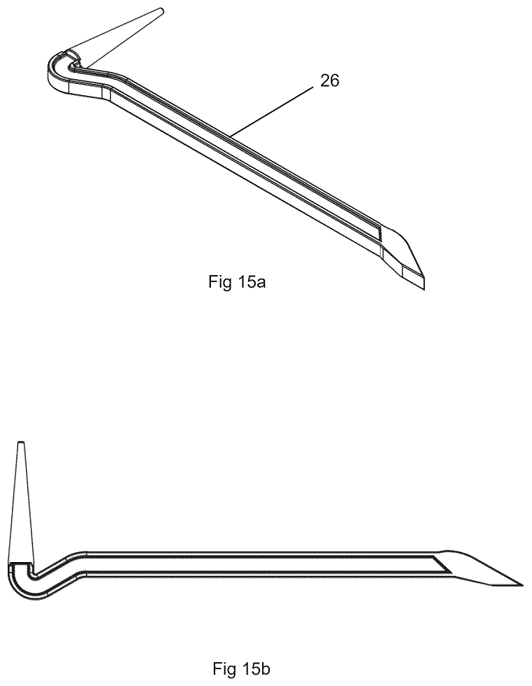

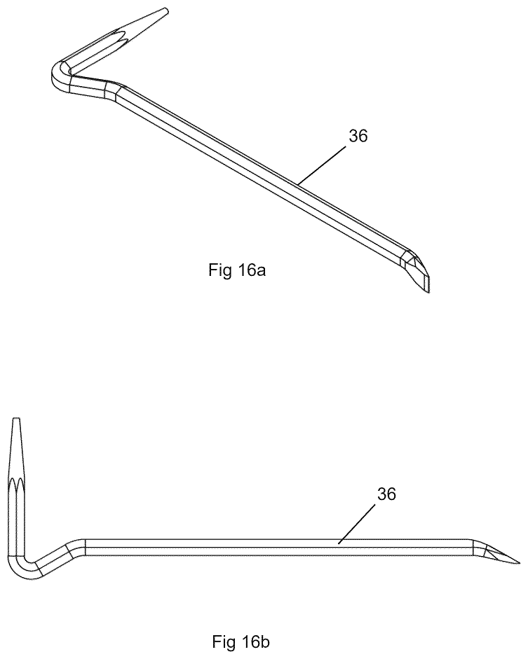

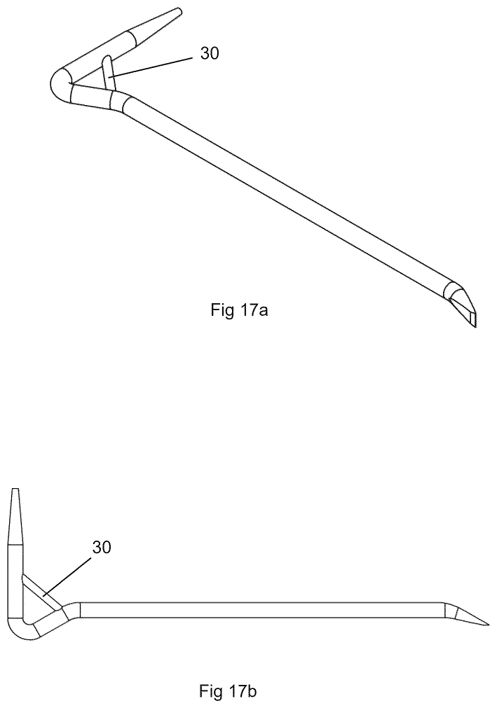

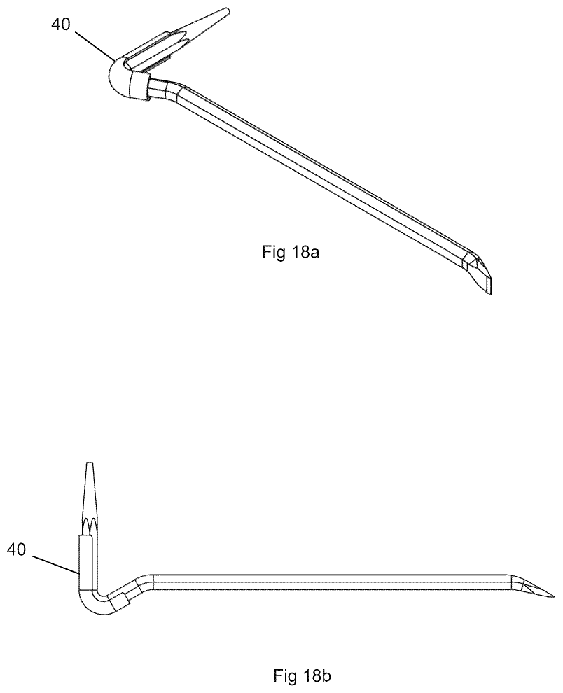

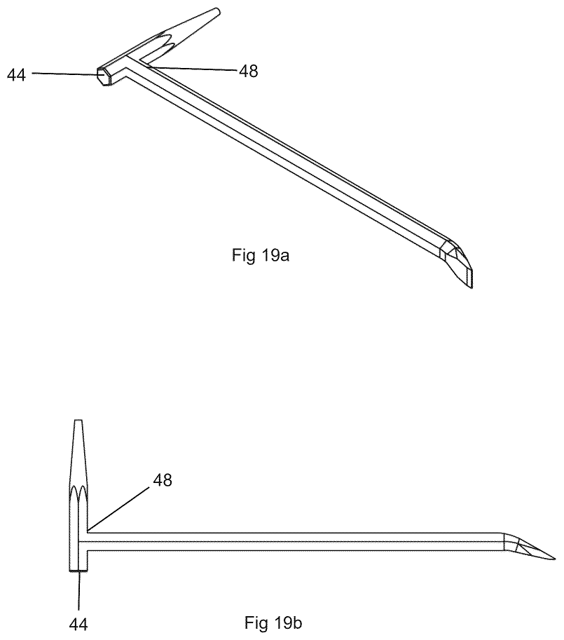

FIGS. 10a through 18b illustrate alternate embodiments of the alignment tool. FIGS. 10a and 10b illustrate an embodiment having handle with an I shaped cross section 26 and a cutout 28. FIGS. 11a and 11b illustrate an embodiment having a reinforcing bar 30 extending between the head and the handle. FIGS. 12a and 12b illustrate a tool having a reinforcing bar with the first end of the handle having a spherical grasping end 38. FIGS. 13a and 13b illustrate a tool with a handle having a circular cross section. FIGS. 14a and 14b illustrate a tool having a handle with a hexagonal cross section 36 and a second end having a spherical grasping end. FIGS. 15a and 15b illustrate a tool having a handle having an I shaped cross section. FIGS. 17a and 17b illustrate a tool having a handle with a cylindrical shape 37 and a reinforcing bar. FIGS. 18a and 18b illustrate a tool having a reinforced striking area 40. FIGS. 19a and 19b illustrate an alternate embodiment of the tool having a non-radiused elbow 48 having a striking end 44 formed on the tapered head.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

1. A steel component alignment tool comprising:
an elongate handle extending from a first end of said tool to an elbow, said elbow connecting the elongate handle to a tapered alignment head, said tapered alignment head extending generally perpendicular to said elongate handle, said tapered alignment head tapering toward a second end of said alignment tool such that said head comprises a tip forming said second end of said tool;
wherein said tool comprising a striking area configured for striking a hammer onto the radiused elbow opposite from the tapered alignment head to force said tapered alignment head through misaligned apertures in adjacent steel components; and
wherein said elongate handle is configured to provide leverage to said tapered alignment head to remove said tapered alignment head from said apertures following alignment of said apertures.

2. The steel component alignment tool of claim 1, wherein said elbow comprises said striking area.

3. The steel component alignment tool of claim 2 wherein said elbow is reinforced to allow for striking by said hammer.

4. The steel component alignment tool of claim 1 wherein said elbow is radiused.

5. The steel component alignment tool of claim 1 wherein said head comprises said striking area.

6. The steel component alignment tool of claim 1 wherein said second end of said handle comprises a spherical grasping end.

7. The steel component alignment tool of claim 1 wherein said tapered alignment end is approximately seven inches long and wherein said handle is between approximately two feet or greater in length, and less than or equal to approximately three feet in length.

8. A method of using a steel component alignment tool comprising:
the step of providing a steel component alignment tool comprising
an elongate handle extending from a first end of said tool to an elbow, said elbow connecting the elongate handle to a tapered alignment head, said tapered alignment head extending generally perpendicular to said elongate handle, said tapered alignment head tapering toward a second end of said alignment tool such that said head comprises a tip forming said second end of said tool;
wherein said tool comprising a striking area configured for striking a hammer onto the tool opposite from the tapered alignment head to force said tapered alignment head through misaligned apertures in adjacent steel components; and
wherein said elongate handle is configured to provide leverage to said tapered alignment head to remove said tapered alignment head from said apertures following alignment of said apertures;
The step of inserting the tapered alignment head through two adjacent alignment openings of two adjacent steel support structures to align said structures;
The step of applying an impact force to said striking area of said tool to drive said tapered head into said apertures causing said apertures and said steel components to align;
The step of applying a clamp to retain alignment of said apertures and said steel components to align; and
The step of applying force to said elongate handle to apply leverage said tapered head to remove said tapered head from said aligned apertures.

9. The method of claim 8 wherein said step of inserting the tapered alignment head through two adjacent alignment openings of two adjacent steel support structures to align said structures comprises applying force with a hammer to said tool to align said adjacent alignment openings.

10. The method of claim 8 wherein said step of inserting the tapered alignment head through two adjacent alignment openings of two adjacent steel support structures to align said structures comprises moving said handle to rotate such that said tool pivots on said elbow to apply force to said adjacent openings to align said openings.

11. The method of claim 8 further comprising the step of moving said handle to rotate said alignment head such that that said tool pivots on said elbow to apply force to free said tool from said aligned openings.

12. The method of claim 8 wherein said steel component are adjacent support components of a concrete form system.
